(19) United States
(12) Patent Application Publication
(10) Pub. No.: US 2005/0275536 A1
(43) Pub. Date: Dec. 15, 2005

(54) Appliance security system

(76) Inventors: Santo Celi, Salisbury (AU); Jim Chan, Penshurst (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/866,644

(22) Filed: Jun. 10, 2004

(51) Int. Cl. E05B 45/06

(52) U.S. Cl. 340/542

(57) ABSTRACT

An appliance security system to secure appliances such as air or water heaters, air conditioners, pumps, cooling, cooking or washing appliances against theft from building sites. The system includes a lock means acting on control means of the appliance, and code entry means wherein entry of the code into the code entry means permanently deactivates the lock. This is performed by an authorised person after the risk of theft has diminished.

### BACKGROUND OF THE INVENTION

1. Field of the Invention

The invention relates to appliance security systems, in particular security devices for prevention or deterrence of theft of appliances which are permanently installed in buildings. It will be convenient to describe the invention with particular reference to application for prevention of theft of appliances which are installed during construction of a building, especially in a domestic dwelling or dwellings, although it would be appreciated that the invention may have wider application.

2. Description of the Related Art

During construction of domestic dwellings a range of appliances are generally installed. These appliances may include gas, solar or electric hot water services, heating systems, furnaces, air-conditioning units, ovens, stoves, dishwashers, in-built vacuum systems, garage door activators and motors, spa baths and associated equipment and pumps and filters for swimming pools. Many of these appliances must be installed outside the building.

The cost of such appliances can be quite substantial and as a consequence, such appliances are often targeted for theft. Although such items are not readily portable, security on building sites is often inadequate and these appliances are particularly vulnerable. Security fencing and security patrols may be provided to improve security on building sites, however, the effectiveness of such measures is limited. The costs of 24 hour security patrols may be prohibitive. In addition, some theft of appliances may be by people authorised to access the site, making enforcement difficult. A range of anti-theft devices have been proposed for more portable electronic apparatus such as televisions, video cassettes recorders, personal computers, stereo equipment and the like for example, in U.S. Pat. No. 4,987,406. These devices generally render the apparatus inoperative after occurrence of a disabling event like movement of the apparatus from one place to another. This type of apparatus are more frequently the target of theft from domestic residences after they have been purchased by the consumer and taken home, installed and used as they are generally easily removed during opportunistic breakings and enterings.

The likelihood of theft of permanently installed appliances such as fixed air-conditioning after installation while the building is occupied is quite remote but much higher prior to installation on the building site.

Clearly, the costs associated with replacing stolen appliances is undesirable and leads to greater building costs and/or insurance premiums. Thus, it is an object of the invention to reduce instances of theft of appliances particularly from building sites. It is also an object of the invention to provide such security functionality without major or costly alteration to existing appliance hardware or software.

### SUMMARY OF THE INVENTION

In accordance with one aspect of the invention there is provided an appliance security system comprising:
a controller for selectively enabling and disabling operation of the appliance,
a lock for the controller, the lock having a first condition wherein it prevents the controller from functioning, and
a code entry facility for co-operation with the lock, wherein transmission of a predetermined code from the code entry facility to the lock changes the lock to a second condition at which the lock is deactivated thereby allowing functioning of the controller whereby the appliance is secured against unauthorized use whilst the lock is in its first condition.

Preferably, the appliance is one which is to be permanently installed and performs a domestic utility function especially a heating appliance, air-conditioner or cooler, although other appliances such as permanently installed cooking, washing, vacuuming, door actuation, filtering or pumping appliance or the like may be the subject of other embodiments.

The appliance will have a controller for controlling the operation of the appliance, which may be a simple on/off operation, or a more complex on/off operation coupled with a thermostatic control or secondary control functions. It will be appreciated that in many appliances the control means incorporates a microprocessor or other electronic circuitry. In the normal use of the appliance the controller is switched by the user to operate the appliance for example, setting a desired temperature on a heating or cooling appliance. The controller may be located on the appliance itself or it may be located remote from but in communication with the main appliance apparatus. For example, the controller may be a thermostat control located in a selected situation in a dwelling, where the main heating or cooling appliance apparatus is located in a discrete position outside the dwelling.

There is also provided a lock to prevent the selective enablement and disablement of the controller. In a preferred embodiment the appliance is supplied from the manufacturer with the lock in a locked state so that the controller cannot function. In other words, once the appliance leaves its place of manufacture it cannot be operated until the lock is deactivated therefore rendering the appliance useless unless it is subsequently unlocked thereafter. In one embodiment, the lock may act on a uniquely coded remote control unit which communicates with the controller, thus preventing a signal from being transmitted from the remote control unit to the controller when the lock is activated.

The lock is preferably an electronic lock, i.e., circuitry or software which locks the functioning of the controller.

There is further provided a code entry facility for conveying a code to permanently deactivate the lock when the code matches a corresponding memorised code in the lock. Generally the code would be conveyed to the lock by the code entry facility after installation of the appliance and after the building has reached a stage where the risk of theft has passed. In one embodiment, the code entry facility for conveying the code is a separate electronic key which may be plugged into a communications port in the appliance to transmit the code to unlock the lock. After this operation, the electronic key, which is preferably of low cost and low complexity, may be disposed of as it has no further function.

In yet another embodiment, the appliance can be locked out of operation until an authorized installer deactivates the lock for an initial period, and once that period has expired, the lock then reactivates to prevent functioning of the controller. The lock may then be subsequently deactivated, for example by the home owner, once the building becomes occupied, as described above. Preferably the lock is permanently deactivated at this stage as the risk of theft of the appliance has passed. The initial period for which the lock is deactivated may be selected from one of a number of options, for example 12 hours, 48 hours or 30 days. This enables the appliance to be installed, operated and commissioned then locked out prior to hand over to the end customer. Such a code entry facility may be used by an authorized installer for multiple appliances.

In another embodiment, the code entry facility for conveying the code is a remote control unit supplied with the appliance which is normally used to communicate with the controller. The remote control may have a dedicated ‘activation’ program operated prior to the first use of the appliance where the code is transmitted and the lock may be permanently deactivated.

In another embodiment there is provided a method of deferring theft of an appliance for fixing in a building, the appliance including a controller for selectively enabling and disabling operation of the appliance, the method comprising the steps of:
(i) providing a lock for the controller;
(ii) conditioning the lock to a first condition whereat it prevents functioning of the controller;
(iii) providing a data entry facility for use with the lock, and
(iv) conditioning the data entry facility and the lock such that entry of a first code into the data entry facility will deactivate the lock to a second position whereby it will allow functioning of the controller,
   wherein theft of the appliance is deterred whilst the lock is in the first condition whereby the appliance cannot be activated.

It will now be convenient to describe certain aspects of the invention with reference to preferred embodiments and drawings. It is to be understand that the following description relates to preferred embodiments only and is not intended to limit the scope of the invention.

### BRIEF DESCRIPTION OF THE DRAWINGS

FIG. 1 is a schematic diagram of an appliance and code entry facility of the present invention.

FIG. 2 is a schematic diagram of an appliance and remote controller with code entry facility of the present invention.

FIG. 3 is a plan of an electronic key for use with the present invention.

### DETAILED DESCRIPTION OF THE PREFERRED EMBODIMENT

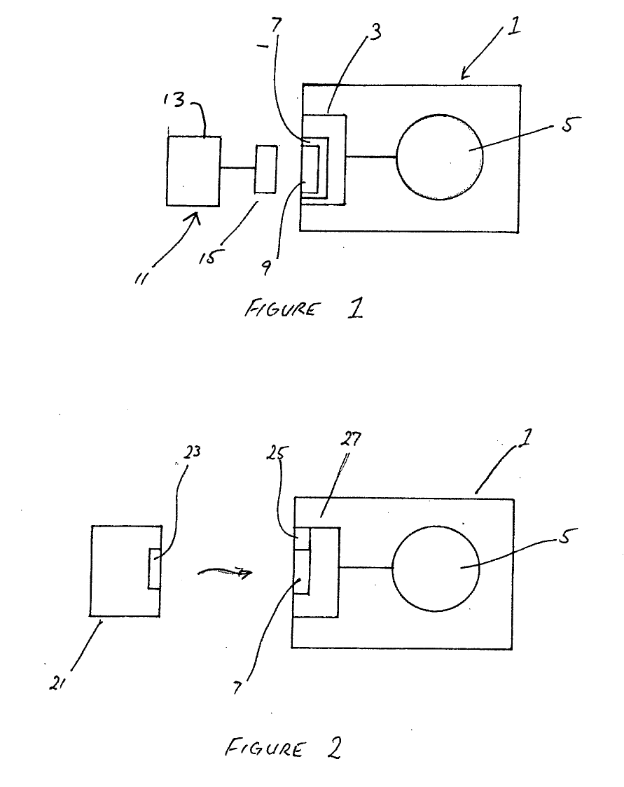

In FIG. 1, appliance 1 has a controller 3 for selectively enabling an disabling operation of the appliance 1. Where the appliance 1 is, for example, an air conditioner, heater, filter or pump, the controllers may control functioning of a motor, valve, burner or combination of these, generally shown as part 5. Lock 7 is associated with controller 3 and in a first condition prevents the controllers from functioning and controlling part 5. In the embodiment of the appliance 1 shown in FIG. 1, there is no pre-existing method of entering digital data into lock 7 because such an appliance does not use a communications socket, but may use a “Honeywell”™ type input. Because there is a need to transmit a digital code to controller 3 to unlock it, and a simple contact is not generally suited to do this, a multi-pin socket 9 is provided as a communications port. Electronic key 11 includes a key body 13 and a multi-pin plug 15 which can be located in the corresponding multi-pin socket 9. Key body 13 has data entry keys more clearly shown in FIG. 3. Keys 17a, 17b and 17c are each labelled with a different time duration, such as 12 hours, 48 hours or 30 days.

In one embodiment, at an appropriate point during the manufacture of appliance 1, a code is entered into a non-volatile memory of controller 3. Different appliances may be designated with different individual codes. Once the code is installed the appliance 1 may be pre-programmed to only run for a limited time, for example, an hour, to enable testing of the appliance immediately after installation by a tradesman. After that initial testing period has expired, the main controller 3 will be locked out from functioning until a further code matching the individual code is entered into lock 7 to disable the lock out function. Preferably, appliance 1 is supplied from the manufacturer with lock 7 in a locked state so that controller 3 is prevented from functioning. Once the tradesman has then installed the appliance and is ready to test it, multi-pin plug 15 is inserted into multi-pin socket 9 and one of keys 17a, b or c is pressed so that the lock changes to a second condition where it is deactivated for a limited time. Electronic key 11 is then removed from multi-pin socket 9 and the tradesman can test appliance 1. After the selected time period has expired lock 7 will automatically revert to its first condition where it again prevents the controllers from functioning.

Appliance 1 then remains locked until the danger of theft during construction of the house or building has passed. When appliance 1 is ready to be commissioned to commence its normal functioning, electronic key 11, or some similarly configured electronic key with a multi-pin plug can be inserted into multi-pin socket 9 and a button 19 depressed so that electronic key 11 sends a code to lock 7 to change the lock 7 to the second condition where the lock is deactivated and allowing functioning of the controllers. Preferably this permanently deactivates lock 7.

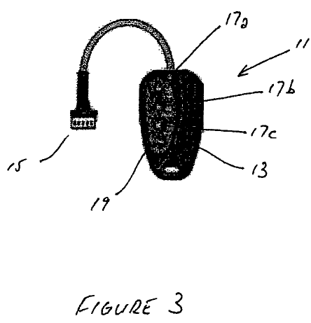

In an alternative embodiment shown in FIG. 2, appliance 1 is controlled by way of a remote control 21 having a wireless transmitter 23 communicating with a wireless receiver 25 associated with slave controller 27. Slave controller 27 controls the functioning of part 5 which again may be a motor, pump, valve, or the like. In this embodiment the master controller is remote from appliance 1 and is capable of transmitting a digital signal to wireless receiver 25. It is therefore convenient that instead of using a separate electronic key as shown in FIG. 1, the remote control 21 can be programmed to transmit the locking and unlocking data to lock 7 via wireless receiver 25 which will comprise circuitry associated with slave controller 27.

The use of the lock code and unlocking function can be limited to a once only action to avoid accidental locking of the product through the rest of its serviceable life. This would stop any later problems of the appliance 1 being locked inadvertently long after it has been installed and the building in which it is installed has been occupied.

To avoid altering any software already used in a remote 21 control which may conventionally be supplied with an appliance 1 the address facility to establish communication between the remote control processor and the main control may be used as is. On a ‘virgin unit’, the communication address function is carried out as normal. In one embodiment, another 4 digit code may be entered straight after the address code and is accepted as a PIN number or to activate the lock function, initialising a pre-programmed PIN number. The unlock function is performed in the same manner, unlocking the unit and disabling it from ever being locked again. This method means the existing remote controllers used in such appliances can incorporate the invention without alteration. Changes can be made to the main controller software to enable use of its non-volatile memory in this manner.

Alternatively, the appliance 1 may be manufactured and supplied in an unlocked state, and activation of the lock-out function may initially be caused by entry of a code into the main control.

In one embodiment, each key may be code set by use and cannot be altered. The PIN number is also attached to the key so that a control board can be locked with a matching number. There also is the possibility of the manufacturer maintaining a master key to which access is restricted and coding of the master key may change from time to time.

In one embodiment, after the key is used once for final unlocking there is no further use for it and it may be thrown away. It may also be possible to lock the unit, provided it is a “virgin” unit as outlined previously.

This key may be a small PCB, with only one dedicated integrated circuit. The manufacture during production may program them in sequential numbers which are unalterable. The operation power for the key may be obtained from the multi-pin socket 9 of the appliance 1 so the content of the key is kept quite simple.

In some circumstances it may be necessary to recall an individual PIN number; for example if the PIN is lost. In one embodiment a fault LED of the controller 3 could identify the PIN code and could be accessed in a suitable form. For added security the observed code may be in the form of a number of flashes arranged in digits of the fault LED. This could be either the actual representation of the PIN code which has to be input or an encrypted code which must be passed through a ‘filter’ available only at the manufacturer's selected centres, where the actual unlock code is determined. Obviously this process is only used when the assigned PIN number is lost and verification of those wishing to know is ascertained. The filter may be a special algorithm performed on flash count reading that produces the actual 4 digit unlock code. This is obviously a higher level of security designed to stop the unlock code recovery being easily obtainable by those in the “know” and to delete the necessity of a database of unlock codes to serial numbers being stored.

The above is one concept and, there are many possible variations of the above scheme using a PIN number system.

It is to be understood that various alterations, modifications and/or additions may be introduced into the parts previously described without departing from the spirit of the invention.

1. An appliance security system comprising:
a controller for selectively enabling and disabling operation of an appliance,
a lock for the controller, the lock having a first condition wherein it prevents the controller from functioning, and
a code entry facility for co-operation with the lock, wherein transmission of a predetermined code from the code entry facility to the lock changes the lock to a second condition at which the lock is deactivated thereby allowing functioning of the controller whereby the appliance is secured against unauthorized use whilst the lock is in its first condition.

2. An appliance security system according to claim 1 wherein said appliance is supplied from the manufacturer with the lock in said first condition.

3. An appliance security system according to claim 2 wherein the lock may be permanently deactivated once the appliance has been installed.

4. An appliance security system according to claim 1 wherein said appliance is one of a domestic air heater, an air conditioner, a cooking appliance, a cooling appliance, a washing appliance, a vacuuming appliance, a door actuator, a filtering appliance or a pumping appliance.

5. An appliance security system according to claim 1 wherein said lock comprises an electronic lock.

6. An appliance security system according to claim 1 wherein said lock may be deactivated for a set period upon entry of a test code via the code entry facility.

7. An appliance security system according to claim 1 wherein said code entry facility comprises an electronic key separable from and communicable with said lock.

8. An appliance security systems according to claim 1 wherein said code entry facility is integrated with said controller, and said controller is remote from said appliance.

9. A method of deterring theft of an appliance fixable in a building, the appliance including a controller for selectively enabling and disabling operation of the appliance, the method comprising the steps of:
(i) providing a lock for the controller;
(ii) conditioning the lock to a first condition whereat it prevents functioning of the controller;
(iii) providing a data entry facility for use with the lock, and
(iv) conditioning the data entry facility and the lock such that entry of a first code into the data entry facility will deactivate the lock to a second position whereby it will allow functioning of the controller,
wherein theft of the appliance is deterred whilst the lock is in the first condition whereby the appliance cannot be activated.

10. A method according to claim 9 wherein a second code may be entered into the data entry facility which deactivates the lock for a limited duration.

11. A method according to claim 10 wherein the first code may be entered once the risk of theft has been passed.

12. A method according to claim 9 wherein entry of the first code permanently deactivates the lock.
